(19) United States
(12) Patent Application Publication
(10) Pub. No.: US 2025/0242240 A1
(43) Pub. Date: Jul. 31, 2025

(54) ONE OR MORE NON-TRANSITORY COMPUTER-READABLE STORAGE MEDIA HAVING GAME PROGRAM STORED THEREIN, GAME SYSTEM, GAME APPARATUS, AND GAME PROCESSING METHOD

(71) Applicant: Nintendo Co., Ltd., Kyoto (JP)

(72) Inventor: Masami YONE, Kyoto (JP)

(21) Appl. No.: 18/923,136

(22) Filed: Oct. 22, 2024

(30) Foreign Application Priority Data
Jan. 26, 2024 (JP) 2024-010394

(51) Int. Cl. A63F 13/52; A63F 13/54

(52) U.S. Cl. CPC A63F 13/52; A63F 13/54

(57) ABSTRACT

A game image including an individual image of each of a plurality of games in each of a plurality of regions is displayed, and a game sound for a game as a sound output target among game sounds for the plurality of games is outputted. If a game progress state of the game as the sound output target satisfies a first condition, the sound output target is changed to the game, corresponding to another one of the regions, not satisfying the first condition.

### CROSS REFERENCE TO RELATED APPLICATION

This application claims priority to Japanese Patent Application No. 2024-10394 filed on Jan. 26, 2024, the entire contents of which are incorporated herein by reference.

### FIELD

The present disclosure relates to information processing for games, etc.

### BACKGROUND AND SUMMARY

Hitherto, there have been games in which the game screen is divided and displayed, and a sound is outputted at a sound volume corresponding to the area of each divided region.

For example, when each player plays an independent game, BGM may be outputted for each divided region, or when many players play, sounds may become excessively complicated.

Therefore, it is an object of the exemplary embodiments to provide one or more non-transitory computer-readable storage media having a game program stored therein, etc., which allow sounds to be appropriately outputted when a game is played with screens for many players displayed simultaneously.

In order to attain the object described above, for example, the following configuration examples are exemplified.

One configuration example is one or more non-transitory computer-readable storage media having stored therein a game program causing one or more processors of an information processing apparatus to: control a plurality of games simultaneously, based on operation inputs based on operations by a plurality of players; display a game image including an individual image of each of the plurality of games in each of a plurality of regions; set the game corresponding to any of the regions as a sound output target; output a game sound for the game as the sound output target among game sounds generated based on game processing of the plurality of games; and if a game progress state of the game as the sound output target satisfies a first condition, change the sound output target to the game, corresponding to another one of the regions, not satisfying the first condition.

According to the above configuration example, even when a game image including individual images for many players is displayed and the games are played simultaneously, the game sound can be appropriately outputted without becoming excessively complicated.

In another configuration example, the plurality of games may be identical games.

According to the above configuration example, since the sound output target is changed between the identical games, the players of the games that are not the sound output target can enjoy the games, and the sound output target can be changed in a relatively natural way.

In another configuration example, the plurality of games may be started simultaneously from a common scene.

According to the above configuration example, since the identical games start simultaneously from the common scene, for example, the BGM, etc., are substantially the same for all the games, so that the players of the games that are not the sound output target can enjoy the games with less uncomfortable feeling.

In another configuration example, the game program may further cause the one or more processors to: stop or end a game satisfying the first condition among the plurality of games; and perform a win/loss determination for the plurality of players, based on a speed at which the first condition is satisfied.

According to the above configuration example, in a time race game, the game sound can be outputted focusing on the uncleared games.

In another configuration example, the game program may further cause the one or more processors to, for each of the plurality of games, output a predetermined sound effect if the first condition is satisfied, regardless of whether the game is the sound output target.

According to the above configuration example, since the predetermined sound effect for the case where the first condition is satisfied is also outputted for the games that are not the sound output target, it is possible to suppress the loss of immersion of the players of the games that are not the sound output target.

In another configuration example, the game program may further cause the one or more processors to, for each of the plurality of games, output a predetermined sound effect if a second condition is satisfied, regardless of whether the game is the sound output target.

According to the above configuration example, since the predetermined sound effect for the case where the second condition is satisfied is also outputted for the games that are not the sound output target, it is possible to suppress the loss of immersion of the players of the games that are not the sound output target.

In another configuration example, the game program may further cause the one or more processors to output a predetermined sound effect if a third condition with respect to all of the plurality of games is satisfied.

According to the above configuration example, since the predetermined sound effect for the case where the third condition is satisfied is also outputted for the games that are not the sound output target, it is possible to suppress the loss of immersion of the players of the games that are not the sound output target.

In another configuration example, the plurality of games may be games executed by a plurality of emulators, respectively.

According to the above configuration example, when the respective games are executed by the plurality of emulators, respectively, and game sounds for the respective games are generated, the game sounds can be appropriately outputted without becoming excessively complicated.

In another configuration example, the game program may further cause the one or more processors to: monitor a specific address in a memory at which the game is being executed using the emulator; and determine that the first condition is satisfied, if data on the address satisfies a predetermined condition.

According to the above configuration example, various conditions can be set as the first condition, regardless of the specifications of the existing game executed by the emulator.

According to the exemplary embodiment, it is possible to provide one or more non-transitory computer-readable storage media having a game program stored therein, etc., which allow sounds to be appropriately outputted when a game is played with screens for many players displayed simultaneously.

### BRIEF DESCRIPTION OF THE DRAWINGS

FIG. 1 shows a non-limiting example of a state where a left controller 3 and a right controller 4 are attached to a main body apparatus 2;

FIG. 2 is a block diagram showing a non-limiting example of the internal configuration of the main body apparatus 2;

FIG. 3 is a block diagram showing a non-limiting example of the internal configurations of the main body apparatus 2, the left controller 3, and the right controller 4;

FIG. 4 illustrates a non-limiting example of the case of playing a game on a television monitor;

FIG. 5 illustrates a non-limiting example of a game screen;

FIG. 6 illustrates a non-limiting example of the game screen;

FIG. 7 illustrates a non-limiting example of the game screen;

FIG. 8 illustrates a non-limiting example of the game screen;

FIG. 9 illustrates a non-limiting example of sound output;

FIG. 10 illustrates a non-limiting example of the game screen;

FIG. 11 illustrates a non-limiting example of the game screen;

FIG. 12 illustrates a non-limiting example of the game screen;

FIG. 13 shows a non-limiting example of various types of data stored in a DRAM 85; and

FIG. 14 is a non-limiting example of a flowchart of game processing.

### DETAILED DESCRIPTION OF NON-LIMITING EXAMPLE EMBODIMENTS

Hereinafter, an exemplary embodiment will be described.

### Hardware Configuration of Information Processing System

Hereinafter, an information processing system (game system, game apparatus) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment will be described, and then, the control of the game system 1 according to the exemplary embodiment will be described.

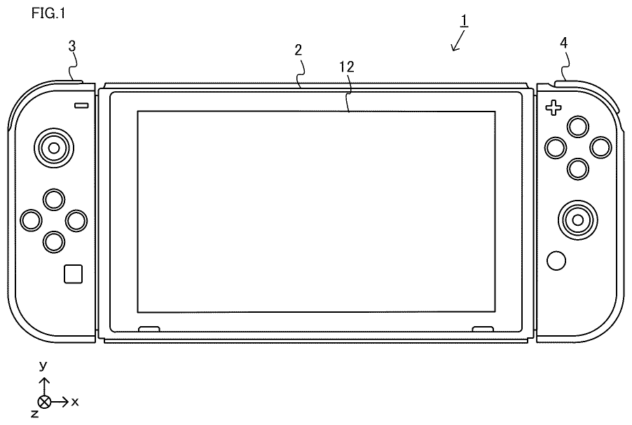

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes in the game system 1. The main body apparatus 2 includes a display 12. Each of the left controller 3 and the right controller 4 is an apparatus including operation sections with which a user provides inputs.

The main body apparatus 2 also includes speakers 88, and sounds such as sound effects are outputted from the speakers 88.

The main body apparatus 2 also includes a left terminal 17 for the main body apparatus 2 to perform wired communication with the left controller 3, and a right terminal 21 for the main body apparatus 2 to perform wired communication with the right controller 4.

The main body apparatus 2 also includes a slot 23. The slot 23 is provided on an upper side surface of a housing of the main body apparatus 2. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

Each of the left controller 3 and the right controller 4 includes various operation buttons, etc. The various operation buttons, etc., are used to give instructions according to various programs (e.g., an OS program and an application program) executed by the main body apparatus 2.

Each of the left controller 3 and the right controller 4 also includes a terminal 42 or 64 for performing wired communication with the main body apparatus 2.

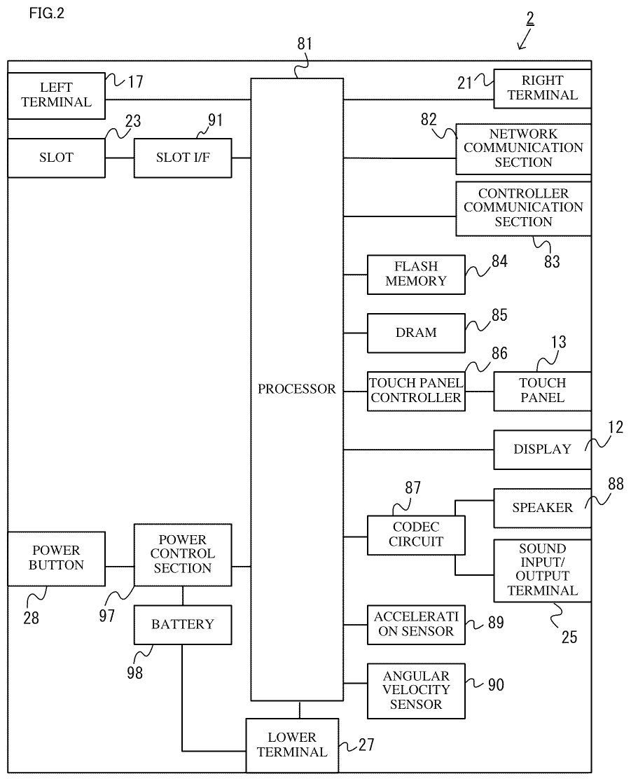

FIG. 2 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is discretionary. In the exemplary embodiment, the controller communication section 83 performs communication compliant with the Bluetooth (registered trademark) standard with the left controller 3 and with the right controller 4.

The processor 81 is connected to the above left terminal 17, the above right terminal 21, and a lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with a cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

The main body apparatus 2 includes a touch panel controller 86, which is a circuit for controlling a touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and the speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

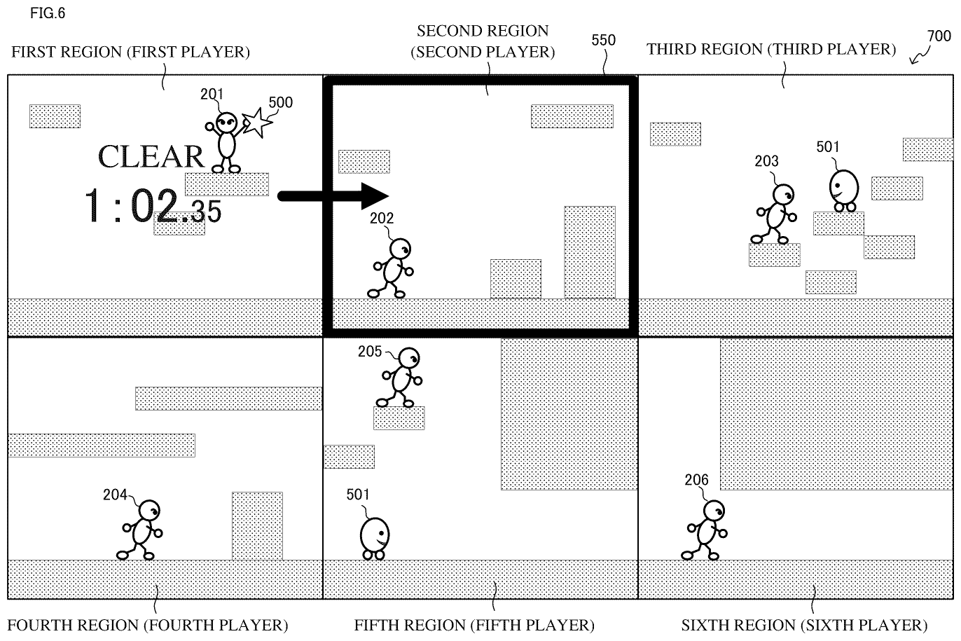

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

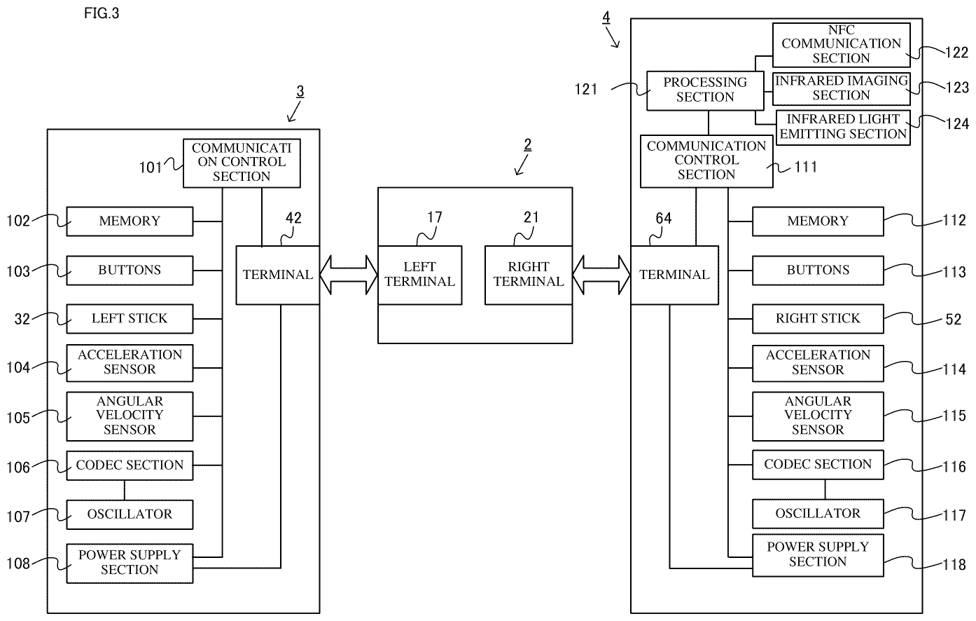

FIG. 3 is a block diagram showing examples of the internal configurations of the main body apparatus 2, the left controller 3, and the right controller 4. It should be noted that the details of the internal configuration of the main body apparatus 2 are shown in FIG. 2 and therefore are omitted in FIG. 3.

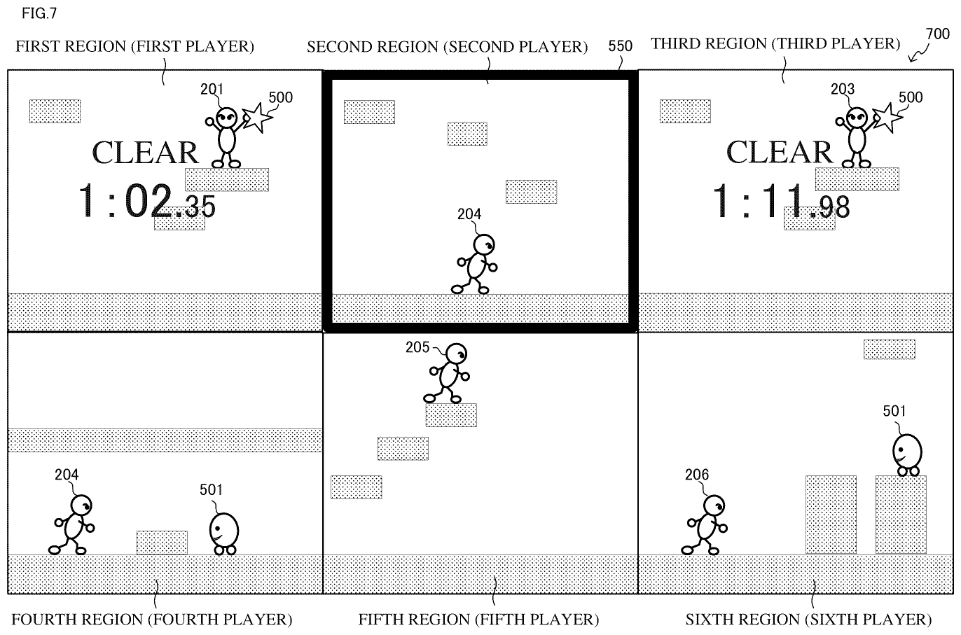

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

The left controller 3 also includes a memory 102 such as a flash memory. The communication control section 101 includes, for example, a microcomputer (or a microprocessor) and executes firmware stored in the memory 102, thereby performing various processes.

The left controller 3 includes buttons 103 (buttons A, B, C, D, E, etc.). The left controller 3 also includes a left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104 and an angular velocity sensor 105. In the exemplary embodiment, the acceleration sensor 104 detects the magnitudes of accelerations along predetermined three axial (e.g., xyz axes shown in FIG. 1) directions. It should be noted that the acceleration sensor 104 may detect an acceleration along one axial direction or accelerations along two axial directions. In the exemplary embodiment, the angular velocity sensor 105 detects angular velocities about predetermined three axes (e.g., the xyz axes shown in FIG. 1). It should be noted that the angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation, or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery). The left controller 3 also includes a codec section 106 and a vibrator 107.

As shown in FIG. 3, the right controller 4 includes a communication control section 111, which communicates with the main body apparatus 2. The right controller 4 also includes a memory 112 which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 (buttons F, G, H, I, J, etc.), a right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108. The right controller 4 also includes a codec section 116, a vibrator 117, an NFC communication section 122, an infrared image capturing section 123, and an infrared light-emitting section 124.

The main body apparatus 2 can also communicate with other controllers (other left controllers 3, other right controllers 4) besides the above-described left controller 3 and right controller 4, and the processor 81 can perform game processing, etc., on the basis of operation data received from many controllers. That is, many controllers can be connected to the main body apparatus 2, and games, etc., can be played by many players using the main body apparatus 2. In the exemplary embodiment, as an example, up to eight players can play games, etc.

### Game Assumed in Exemplary Embodiment

Next, an outline of game processing (an example of the information processing) executed in the game system 1 according to the exemplary embodiment will be described. The game assumed in the exemplary embodiment is a game in which a plurality of identical existing games (sometimes referred to as “individual games”) are simultaneously executed by a plurality of emulator programs (sometimes referred to simply as “emulators”), respectively, and a plurality of players (users) play the plurality of existing games on the same screen simultaneously.

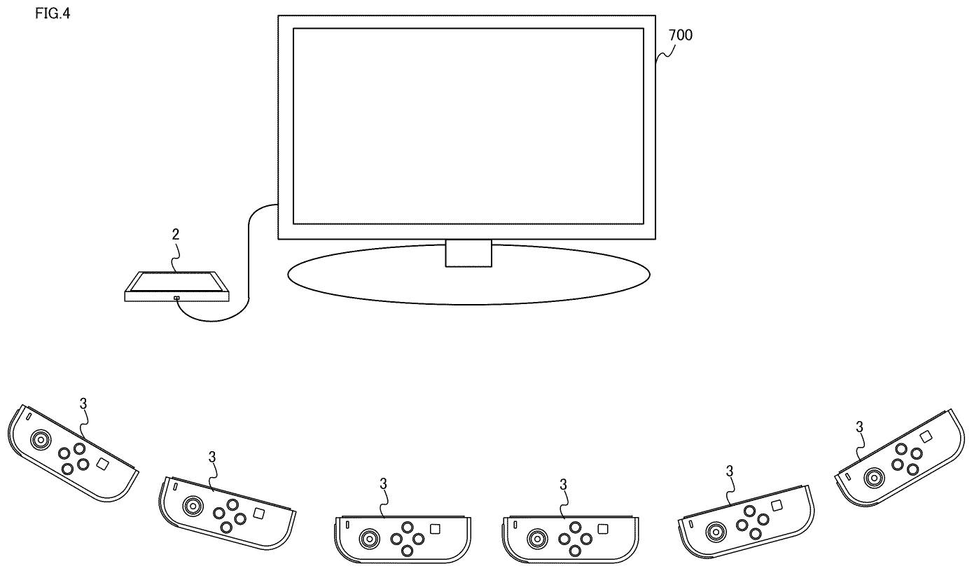

FIG. 4 illustrates an example of a situation in which this game is played. In the exemplary embodiment, as an example, a situation is assumed in which six left controllers 3 operated by six players (not shown) are wirelessly connected to the main unit 2, a game image is displayed on a television monitor 700 connected to the main body apparatus 2 via a wire, and the six players play this game simultaneously. Instead of the left controllers 3, right controllers 4 may be used. As an example, this game can be played simultaneously by up to eight players.

As an example, each emulator operates in the same manner as an existing game program that executes an existing game, reproduces, in the DRAM 85, a data state in the memory of the existing game apparatus when executed by the existing game program, and executes the existing game. By doing so, the emulator generates the same images and sounds as the existing game.

The game program that executes this game processing (sometimes referred to as “control game program”) performs a process of controlling the plurality of emulators described above, etc. In this game processing, in a virtual space (game space) provided for each individual game, many objects are placed on a field, and actions, etc., of the objects are controlled, and an image of the field is taken (rendered) by a virtual camera. Then, the taken images of the respective fields are displayed in a split manner on the game screen of this game (the television monitor 700, the display 12, or the like) as individual images, and the game is advanced. This game is a time race game in which, for example, a player object (sometimes referred to as “player character” or “PO”) that acts in response to operations by a player moves, etc., in each of a plurality of existing games, to compete for a time until achieving a predetermined objective set in advance in this game. The existing games are not limited thereto and may be other types of games.

### Outline of Game Processing of Exemplary Embodiment

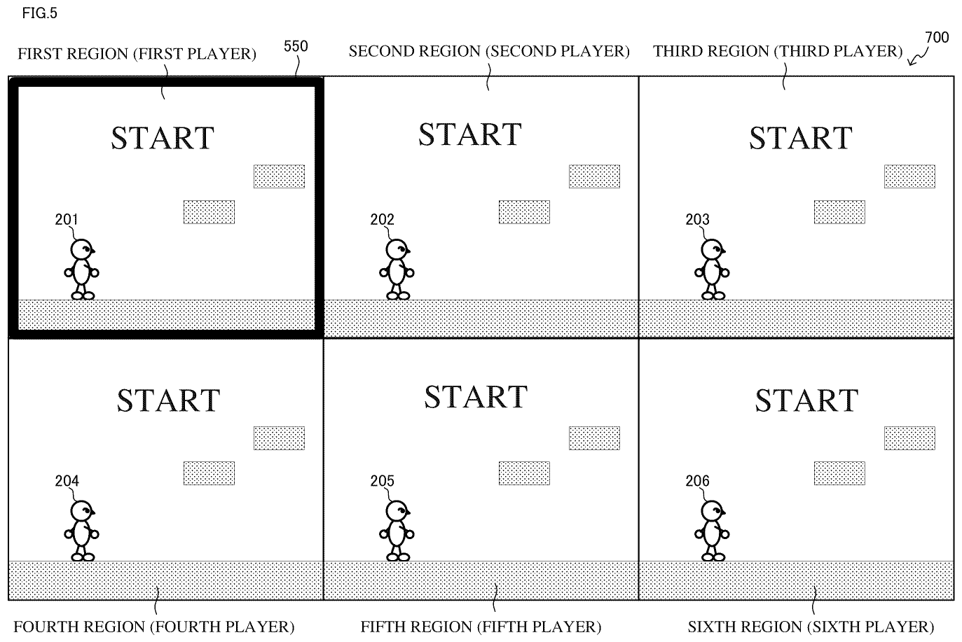

FIG. 5 illustrates a start screen of this game. The start point of this game is not limited to the start point of an existing game, and may be a predetermined point in the middle of the game progress of the existing game, but is the same point in a plurality of existing games executed simultaneously. That is, a start scene of this game is a common scene in the plurality of existing games executed simultaneously. In the exemplary embodiment, as an example, the start point is a predetermined point in the middle of the game progress of an existing game and is the same point in a plurality of existing games.

The goal of this game is not limited to the goal of an existing game, and is a predetermined scene (a predetermined scene in which a predetermined objective is achieved) that can occur in the middle of the game progress of an existing game. In the exemplary embodiment, as an example, the goal is for the PO to acquire a predetermined item in the existing game. The goal may be, for example, defeating a predetermined enemy, reaching a predetermined location, clearing a predetermined stage, etc.

By executing the control game program, the processor 81 monitors a data state (specifically, the state of a specific address) in the DRAM 85 that is reproduced by the emulator, and determines that the goal has been achieved, by determining that the data state has become a state where the goal is achieved. In the exemplary embodiment, the processor 81 determines that the goal has been achieved, for example, by determining that the data state has become a data state where a flag indicating that the PO has acquired a predetermined item is set. As an example, the goal has the same meaning as clearing an individual game.

As shown in FIG. 5, in the start screen, start images of a plurality of identical existing games are displayed in a split manner. In FIG. 5, as an example, start images of six games played by six players, respectively, are displayed in a split manner. An image of a first individual game in which a PO 201 operated by a first player is shown is displayed in a first region, an image of a second individual game in which a PO 202 operated by a second player is shown is displayed in a second region, an image of a third individual game in which a PO 203 operated by a third player is shown is displayed in a third region, an image of a fourth individual game in which a PO 204 operated by a fourth player is shown is displayed in a fourth region, an image of a fifth individual game in which a PO 205 operated by a fifth player is shown is displayed in a fifth region, and an image of a sixth individual game in which a PO 206 operated by a sixth player is shown is displayed in a sixth region. The first to sixth regions are sometimes referred to as “individual regions,” respectively.

As shown in FIG. 5, when the time race of this game is started, “Start” is displayed simultaneously in each of the first to sixth regions, each player becomes enabled to operate the PO simultaneously, and the time race for acquiring a predetermined item starts simultaneously. In this game processing, images and sounds of each individual game are generated by the emulator that executes each individual game. The sounds for each individual game generated by the emulator (sometimes referred to as “individual game sounds”) are BGM (Back Ground Music) and SE (Sound Effect) for the individual game, as an example. Examples of the SE include a sound when the PO jumps, a sound when the PO transforms, a sound when the PO powers up, a sound when the PO is damaged, a sound when the PO attacks and damages an enemy, etc.

The individual game sounds generated by the emulator are outputted for an individual game that is set as a sound output target, and are not outputted for an individual game that is not set as the sound output target. As shown in FIG. 5, a thick frame 550 is displayed at the individual region of an individual game that is set as the sound output target, to indicate that the individual game is set as the sound output target. As shown in FIG. 5, at the start of the game, the individual region that is the sound output target is set to the first region. The individual region that is the sound output target may be indicated by other means instead of the thick frame.

In this game processing, the setting of the sound output target shifts to another uncleared individual game, on the basis of a predetermined order (sometimes referred to as “shift order”) when the individual game that is the sound output target is cleared. In the exemplary embodiment, the shift order is an order of the first individual game, the second individual game, the third individual game, the fourth individual game, the fifth individual game, and the sixth individual game. For example, if the second individual game has already been cleared and the third individual game has not been cleared, when the first individual game that is the sound output target is cleared, the sound output target shifts to the third individual game. Hereinafter, a specific description will be given using the drawings.

Next, as shown in FIG. 6, when the PO 201 in the first individual game (first region) that is the sound output target acquires a predetermined item (sometimes referred to simply as “item”) 500 to clear the game, since the second individual game (second region) has not been cleared, the setting of the sound output target is changed to the second individual game (second region). Accordingly, the state is switched from a state where the individual game sounds for the first individual game are outputted to a state where the individual game sounds for the second individual game are outputted. Also, as shown in FIG. 6, the cleared individual game is stopped or ended, and is continued to be displayed while remaining stopped or ended. Moreover, as shown in FIG. 6, “Clear” is displayed in the first region, and display indicating the time from start to clear (1 minute and 2.35 seconds) is performed. As shown in FIG. 6, an enemy 501 appears in each individual game.

Next, as shown in FIG. 7, when the PO 203 acquires the item 500 to clear the game in the third individual game that is not the sound output target, “Clear” is displayed in the third region, and the time from start to clear is also displayed therein. In this case, since the third individual game is not set as the sound output target, the setting of the sound output target is not changed.

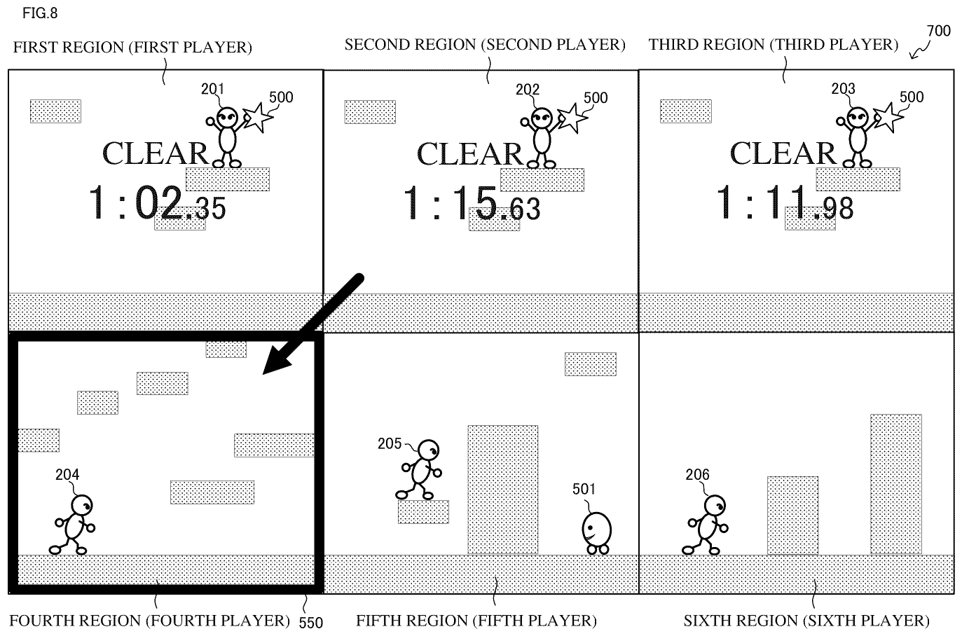

Subsequently, as shown in FIG. 8, when the PO 202 acquires the item 500 to clear the game in the second individual game (second region) that is the sound output target, since the third individual game has already been cleared, the setting of the sound output target is changed to the fourth individual game (fourth region). Accordingly, the state is switched from the state where the individual game sounds for the second individual game are outputted to a state where the individual game sounds for the fourth individual game are outputted. Also, as shown in FIG. 8, “Clear” is displayed in the second region, and the time from start to clear is also displayed therein.

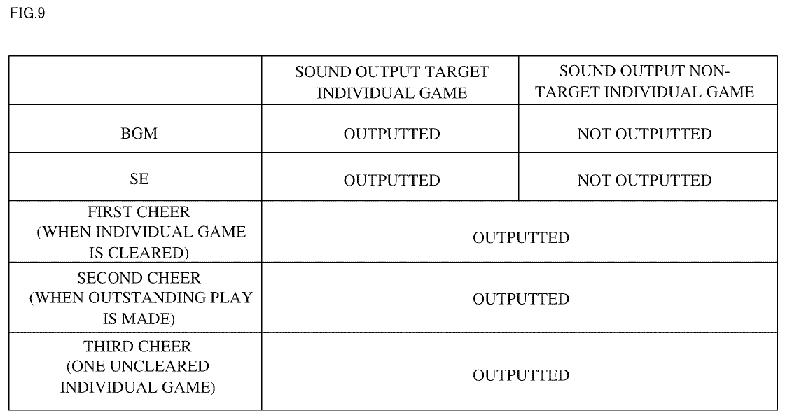

FIG. 9 illustrates sound output in this game processing. As shown in FIG. 9, the BGM and the SE are outputted for an individual game that is set as the sound output target, and are not outputted for an individual game that is not set as the sound output target. The BGM and the SE are generated by each emulator that executes an individual game, but whether or not the BGM and the SE are outputted is controlled by the control game program. Also, as shown in FIG. 9, a first cheer, a second cheer, and a third cheer are generated and outputted by the control game program. When the PO acquires the item 500 to clear the individual game, the first cheer is outputted as a cheer praising this clear, regardless of whether the cleared individual game is set as the sound output target. Thus, the first cheer is outputted, for example, when the first individual game is cleared in FIG. 6, when the third individual game is cleared in FIG. 7, or when the second individual game is cleared in FIG. 8.

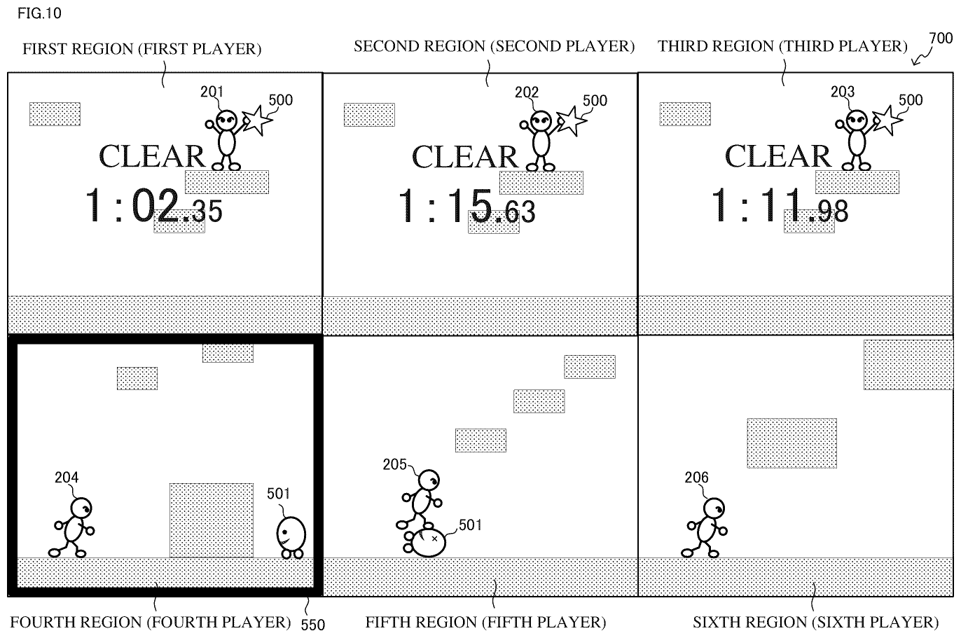

As shown in FIG. 9, when an outstanding play is made in an individual game, the second cheer is outputted as a cheer praising the outstanding play, regardless of whether the individual game in which the outstanding play was made is set as the sound output target. In the exemplary embodiment, the outstanding play is a play in which the PO defeats the enemy 501, as an example. Specifically, as shown in FIG. 10, when the PO 205 defeats the enemy 501 in the fifth individual game, the second cheer is outputted. In addition, although not shown, even when the PO 204 defeats the enemy 501 in the fourth individual game that is the sound output target in FIG. 10, the second cheer is also outputted. The outstanding play is not limited thereto, and may be, for example, a play in which the PO acquires an item other than the item 500, a play in which the PO transforms, a play in which the PO passes through a predetermined location, etc.

A determination as to whether an outstanding play has been made is performed in the same manner as the above-described determination as to whether the goal has been achieved. Specifically, by executing the control game program, the processor 81 monitors a data state (specifically, the state of a specific address) in the DRAM 85 that is reproduced by the emulator, and determines that an outstanding play has been made, by determining that the data state has become a state where the outstanding play is made.

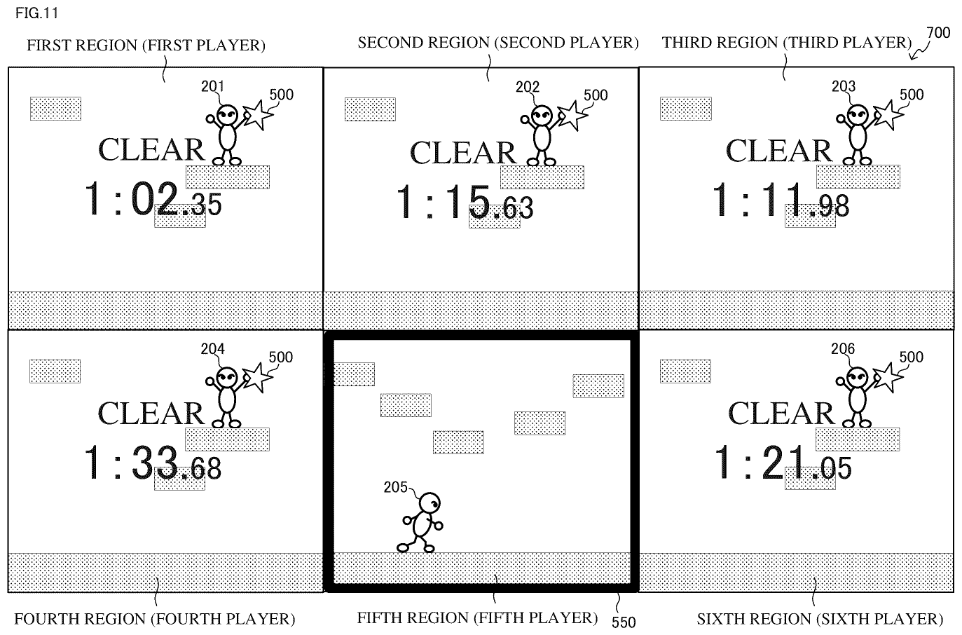

As shown in FIG. 9, during a period when the number of uncleared individual games is one, the third cheer is outputted as a cheer for supporting the play of the last individual game. Specifically, when only the fifth individual game has not been cleared as shown in FIG. 11, the third cheer for supporting the play of the fifth individual game is outputted. The output of the third cheer is not limited thereto, and, for example, the third cheer may be outputted during a period when the number of uncleared individual games is two or less. For example, the third cheer may be a cheer that is outputted at the final stage of the time race to enliven the final stage of the time race. For example, when, in an individual game in which the distance from the PO to the item 500 is the shortest, this distance reaches a predetermined distance (e.g., ⅓ of the initial distance) or less, the third cheer may be outputted to enliven the final stage of the time race. For example, when the number of individual games in each of which the distance from the PO to the item 500 reaches the predetermined distance (e.g., ⅓ of the initial distance) or less reaches a predetermined number (e.g., four) or more, the third cheer may be outputted to enliven the final stage of the time race.

At least two of the first cheer, the second cheer, and the third cheer may be the same sound, or the first cheer, the second cheer, and the third cheer may be different from each other.

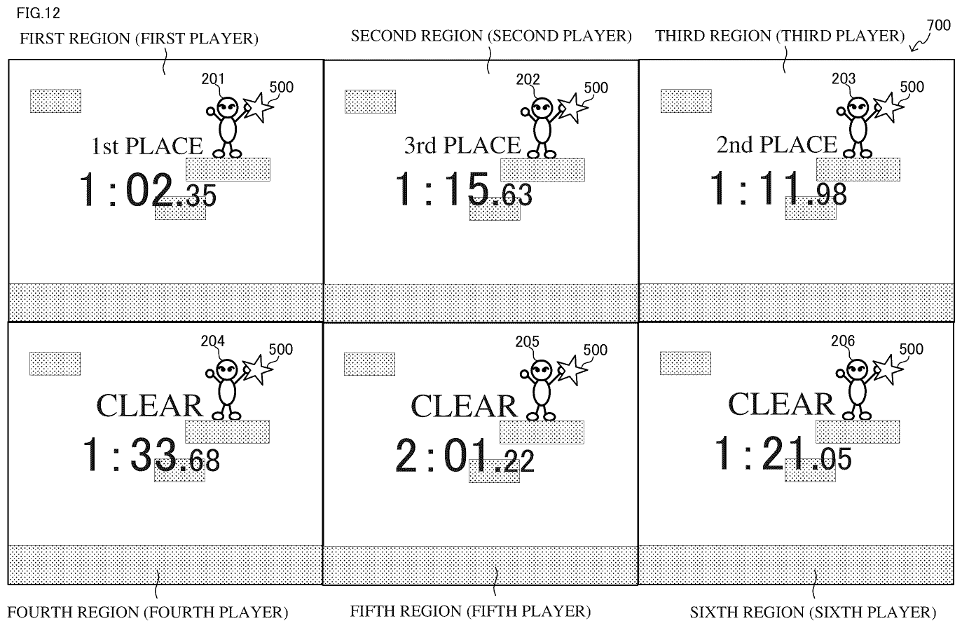

FIG. 12 illustrates an end screen of this game. As shown in FIG. 12, when all the individual games have been cleared and the time from start to clear is displayed for all the individual games, a game end screen in which the thick frame 550 is hidden and, for example, the ranking for the top three individual games is displayed, is displayed. In FIG. 1, the 1st place is displayed in the first region, the 2nd place is displayed in the third region, and the 3rd place is displayed in the second region.

### Details of Information Processing of Exemplary Embodiment

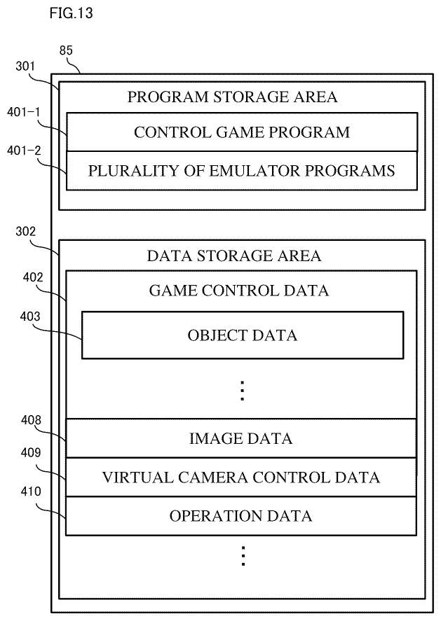

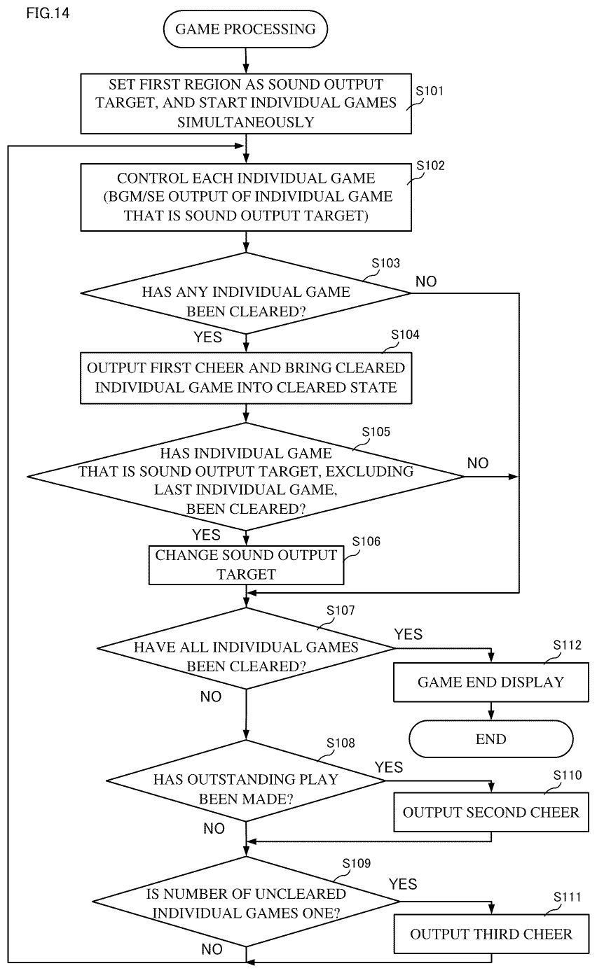

Next, the information processing of the exemplary embodiment will be described in detail with reference to FIG. 13 and FIG. 14.

### Data to be Used

Various types of data used in the game processing will be described. FIG. 13 shows an example of data stored in the DRAM 85 of the game system 1. As shown in FIG. 13, the DRAM 85 is provided with at least a program storage area 301 and a data storage area 302. A control game program 401-1 and a plurality of emulator programs 401-2 are stored in the program storage area 301. In the exemplary embodiment, since the time race can be played by up to eight players, eight emulator programs are stored in the program storage area 301. In the data storage area 302, game control data 402, image data 408, virtual camera control data 409, operation data 410, etc., are stored. The game control data 402 includes object data 403.

The control game program 401-1 is a game program for executing the game processing.

The plurality of emulator programs 401-2 are game programs for executing individual games.

The object data 403 is data of objects to be placed in the virtual space, such as player characters, enemy characters, blocks, items, ground, rocks, stones, trees, and buildings. In addition, the object data 403 includes data of the coordinates, the orientation, the posture, the state, etc., of each object.

The image data 408 is image data of backgrounds, virtual effects, etc.

The virtual camera control data 409 is data for controlling the motion of the virtual camera placed in the virtual space. Specifically, the virtual camera control data 409 is data that specifies the position/orientation, angle of view, imaging direction, etc., of the virtual camera.

The operation data 410 is data indicating the contents of operations performed on a plurality of controllers (left controllers 3 or right controllers 4). As described with reference to FIG. 4, etc., this game can be played simultaneously by up to eight players each operating one controller. Therefore, the operation data 410 is data indicating the contents of operations performed on up to eight controllers.

In addition, various types of data to be used in game processing are stored as necessary in the DRAM 85.

### Details of Game Processing

Next, the game processing according to the exemplary embodiment will be described in detail with reference to a flowchart. FIG. 14 is an example of a flowchart showing the details of the game processing according to the exemplary embodiment. In the following, the processing characteristic of the exemplary embodiment will be mainly described, and the description of other processing such as rendering is omitted.

When the game processing is started and the game is started, the game processing in FIG. 14 is started.

First, in step S101 in FIG. 14, the processor 81 sets the first region corresponding to the first individual game, as the sound output target, as described with reference FIG. 5, and starts a plurality of individual games simultaneously. As already described, the plurality of individual games are executed by the plurality of emulator programs 401-2, respectively. Then, the processing proceeds to step S102.

In step S102, the processor 81 controls each individual game on the basis of the operation data 410. In addition, the processor 81 outputs the BGM and the SE for the individual game that is the sound output target, from the speakers 88. Then, the processing proceeds to step S103.

In step S103, the processor 81 determines whether or not any individual game has been cleared. Specifically, as already described, the processor 81 determines whether or not any individual game has been cleared, by monitoring a data state (the state of a specific address) in the DRAM 85 and determining whether or not the data state becomes a state where the game is cleared. If the result of the determination in step S103 is YES, the processing proceeds to step S104, and if the result of this determination is NO, the processing proceeds to step S107.

In step S104, the processor 81 starts outputting the first cheer as described with reference to FIG. 6, FIG. 9, etc., and brings the cleared individual game into a cleared state. The output of the first cheer ends after being executed for a predetermined time (e.g., 2 seconds). Then, the processing proceeds to step S105.

In step S105, the processor 81 determines whether or not the individual game that is the sound output target, excluding the last individual game, in step S103 has been cleared. If the result of the determination in step S105 is YES, the processing proceeds to step S106, and if the result of this determination is NO, the processing proceeds to step S107.

In step S106, the processor 81 changes the sound output target. Specifically, the processor 81 changes the sound output target from the cleared individual game to the uncleared individual game on the basis of the shift order as described with reference to FIG. 6 to FIG. 8, etc. Then, the processing proceeds to step S107.

In step S107, the processor 81 determines whether or not all the individual games have been cleared. If the result of the determination in step S107 is YES, the processing proceeds to step S112, and if the result of this determination is NO, the processing proceeds to step S108.

In step S112, the processor 81 performs end display of this game as described with reference to FIG. 12. Then, the game processing ends, and this game ends.

In step S108, the processor 81 determines whether or not an outstanding play has been made. If the result of the determination in step S108 is YES, the processing proceeds to step S110, and if the result of this determination is NO, the processing proceeds to step S109.

In step S110, the processor 81 starts outputting the second cheer as described with reference to FIG. 9 and FIG. 10. The output of the second cheer ends after being executed for a predetermined time (e.g., 1.5 seconds). Then, the processing proceeds to step S109.

In step S109, the processor 81 determines whether or not the number of uncleared individual games is one. If the result of the determination in step S109 is YES, the processing proceeds to step S111, and if the result of this determination is NO, the processing returns to step S102.

In step S111, the processor 81 starts outputting the third cheer as described with reference to FIG. 9 and FIG. 11. The output of the third cheer ends when the uncleared individual game is cleared and all the individual games are brought into a cleared state. Then, the processing returns to step S102.

As described above, according to the exemplary embodiment, when individual games played by a plurality of players are displayed in a split manner and the game proceeds, the individual game that is the sound output target is switched in turn (see FIG. 6 to FIG. 9). This can prevent the BGM and the SE from being outputted in an overlapping manner to complicate the game sound. In addition, according to the exemplary embodiment, the first cheer upon clearing an individual game and the second cheer upon an outstanding play (see FIG. 6 to FIG. 10) are outputted regardless of whether the individual game is the sound output target. This can suppress a decrease in immersion of the players of the individual games that are not the sound output target. In addition, according to the exemplary embodiment, when the number of uncleared individual games reaches one, the third cheer (see FIG. 9 and FIG. 11) is outputted. This can enliven the time race until all the individual games have been cleared.

### Modifications

In the above-described exemplary embodiment, the example, in which, when the individual game that is the sound output target is cleared, the sound output target shifts to the uncleared individual game whose turn is next, has been described (see FIG. 6 to FIG. 8, etc.). However, the present disclosure is not limited thereto, and, for example, the sound output target may shift to the uncleared individual game whose turn is next, in accordance with the passage of time after the sound output target is set. For example, the sound output target may shift to the uncleared individual game whose turn is next, on the basis of the shift order, each time a predetermined time (e.g., 10 seconds) elapses.

In the above-described exemplary embodiment, a part or some of the plurality of individual games may be operated on the basis of past play history data to advance the game. For example, in FIG. 5, the third to sixth individual games may be operated on the basis of past play history data.

In the above-described exemplary embodiment, a part or some of the plurality of individual games may each be advanced by a player character, which is a non-player character, being operated by the processor 81. For example, in FIG. 5, the player characters of the third to sixth individual games may be operated by the processor 81.

In the above-described exemplary embodiment, a part or some of the plurality of individual games may each be operated by a player playing through an online connection. For example, in FIG. 5, the third to sixth individual games may be operated by online players.

In the exemplary embodiment, a case in which a series of processes regarding the game processing are executed in a single game apparatus (main body apparatus 2) has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of a so-called cloud gaming may be adopted. For example, a configuration may be adopted in which: the game apparatus (main body apparatus 2) sends operation data indicating operations performed by the user to a predetermined server; various game processes are executed in the server; and the execution result is streaming-distributed as a moving image/sound to the game apparatus (main body apparatus 2).

While the exemplary embodiment and the modifications have been described, the description thereof is in all aspects illustrative and not restrictive. It is to be understood that various other modifications and variations may be made to the exemplary embodiment and the modifications.

What is claimed is:

1. One or more non-transitory computer-readable storage media having stored therein a game program causing one or more processors of an information processing apparatus to:
control a plurality of games simultaneously, based on operation inputs based on operations by a plurality of players;
display a game image including an individual image of each of the plurality of games in each of a plurality of regions;
set the game corresponding to any of the regions as a sound output target;
output a game sound for the game as the sound output target among game sounds generated based on game processing of the plurality of games; and
if a game progress state of the game as the sound output target satisfies a first condition, change the sound output target to the game, corresponding to another one of the regions, not satisfying the first condition.

2. The storage media according to claim 1, wherein the plurality of games are identical games.

3. The storage media according to claim 2, wherein the plurality of games are started simultaneously from a common scene.

4. The storage media according to claim 3, wherein the game program further causes the one or more processors to:
stop or end a game satisfying the first condition among the plurality of games; and
perform a win/loss determination for the plurality of players, based on a speed at which the first condition is satisfied.

5. The storage media according to claim 4, wherein the game program further causes the one or more processors to, for each of the plurality of games, output a predetermined sound effect if the first condition is satisfied, regardless of whether the game is the sound output target.

6. The storage media according to claim 1, wherein the game program further causes the one or more processors to, for each of the plurality of games, output a predetermined sound effect if a second condition is satisfied, regardless of whether the game is the sound output target.

7. The storage media according to claim 1, wherein the game program further causes the one or more processors to output a predetermined sound effect if a third condition with respect to all of the plurality of games is satisfied.

8. The storage media according to claim 1, wherein the plurality of games are games executed by a plurality of emulators, respectively.

9. The storage media according to claim 8, wherein the game program further causes the one or more processors to:
monitor a specific address in a memory at which the game is being executed using the emulator; and
determine that the first condition is satisfied, if data on the address satisfies a predetermined condition.

10. A game system comprising one or more processors, the one or more processors being configured to:
control a plurality of games simultaneously, based on operation inputs based on operations by a plurality of players;
display a game image including an individual image of each of the plurality of games in each of a plurality of regions;
set the game corresponding to any of the regions as a sound output target;
output a game sound for the game as the sound output target among game sounds generated based on game processing of the plurality of games; and
if a game progress state of the game as the sound output target satisfies a first condition, change the sound output target to the game, corresponding to another one of the regions, not satisfying the first condition.

11. The game system according to claim 10, wherein the plurality of games are identical games.

12. The game system according to claim 11, wherein the plurality of games are started simultaneously from a common scene.

13. The game system according to claim 12, wherein the one or more processors are further configured to:
stop or end a game satisfying the first condition among the plurality of games; and
perform a win/loss determination for the plurality of players, based on a speed at which the first condition is satisfied.

14. The game system according to claim 13, wherein the one or more processors are further configured to, for each of the plurality of games, output a predetermined sound effect if the first condition is satisfied, regardless of whether the game is the sound output target.

15. The game system according to claim 10, wherein the one or more processors are further configured to, for each of the plurality of games, output a predetermined sound effect if a second condition is satisfied, regardless of whether the game is the sound output target.

16. The game system according to claim 10, wherein the one or more processors are further configured to output a predetermined sound effect if a third condition with respect to all of the plurality of games is satisfied.

17. The game system according to claim 10, wherein the plurality of games are games executed by a plurality of emulators, respectively.

18. The game system according to claim 17, wherein the one or more processors are further configured to:
monitor a specific address in a memory at which the game is being executed using the emulator; and
determine that the first condition is satisfied, if data on the address satisfies a predetermined condition.

19. A game processing method executed by one or more processors of an information processing apparatus, the game processing method causing the one or more processors to:
control a plurality of games simultaneously, based on operation inputs based on operations by a plurality of players;
display a game image including an individual image of each of the plurality of games in each of a plurality of regions;
set the game corresponding to any of the regions as a sound output target;
output a game sound for the game as the sound output target among game sounds generated based on game processing of the plurality of games; and
if a game progress state of the game as the sound output target satisfies a first condition, change the sound output target to the game, corresponding to another one of the regions, not satisfying the first condition.

20. The game processing method according to claim 19, wherein the plurality of games are identical games.

21. The game processing method according to claim 20, wherein the plurality of games are started simultaneously from a common scene.

22. The game processing method according to claim 21, further causing the one or more processors to:
stop or end a game satisfying the first condition among the plurality of games; and
perform a win/loss determination for the plurality of players, based on a speed at which the first condition is satisfied.

23. The game processing method according to claim 22, further causing the one or more processors to, for each of the plurality of games, output a predetermined sound effect if the first condition is satisfied, regardless of whether the game is the sound output target.

24. The game processing method according to claim 19, further causing the one or more processors to, for each of the plurality of games, output a predetermined sound effect if a second condition is satisfied, regardless of whether the game is the sound output target.

25. The game processing method according to claim 19, further causing the one or more processors to output a predetermined sound effect if a third condition with respect to all of the plurality of games is satisfied.

26. The game processing method according to claim 19, wherein the plurality of games are games executed by a plurality of emulators, respectively.

27. The game processing method according to claim 26, further causing the one or more processors to:
monitor a specific address in a memory at which the game is being executed using the emulator; and
determine that the first condition is satisfied, if data on the address satisfies a predetermined condition.

28. A game apparatus comprising one or more processors, the one or more processors being configured to:
control a plurality of games simultaneously, based on operation inputs based on operations by a plurality of players;
display a game image including an individual image of each of the plurality of games in each of a plurality of regions;
set the game corresponding to any of the regions as a sound output target;
output a game sound for the game as the sound output target among game sounds generated based on game processing of the plurality of games; and
if a game progress state of the game as the sound output target satisfies a first condition, change the sound output target to the game, corresponding to another one of the regions, not satisfying the first condition.
